(19) United States
(12) Patent Application Publication
(10) Pub. No.: US 2016/0049131 A1
(43) Pub. Date: Feb. 18, 2016

(54) ARRAY SUBSTRATE AND LIQUID CRYSTAL DISPLAY

(71) Applicant: Shenzhen China Star Optoelectronics Technology Co. Ltd., Shenzhen, Guangdong (CN)

(72) Inventor: Jinjie WANG, Shenzhen, Guangdong (CN)

(73) Assignee: Shenzhen China Star Optelectronics Technology Co., Ltd., Shenzhen, Guangdong (CN)

(21) Appl. No.: 14/381,018

(22) PCT Filed: Aug. 18, 2014
(86) PCT No.: PCT/CN2014/084638

§ 371 Date: Aug. 26, 2014

(30) Foreign Application Priority Data
Aug. 13, 2014 (CN) 2014103979220

(51) Int. Cl. G09G 3/36

(52) U.S. Cl. CPC G09G 3/3696; G09G 2300/0426

(57) ABSTRACT

An array substrate and a liquid crystal device are disclosed. The array substrate includes a substrate, and a plurality of scanning lines, a plurality of data lines, a plurality of pixel electrodes, a plurality of main pixel switches, a plurality of secondary pixel switches, a plurality of discharging switches, and a plurality of discharging capacitors are arranged on the substrate. Each pixel electrodes includes a main pixel electrode and a secondary pixel electrode. Each main pixel switch respectively connects to one scanning line, one data line, and one main pixel electrode. Each secondary pixel switch respectively connects to one scanning line, one data line, and one secondary pixel electrode. Each discharging switch respectively connects to one scanning line, one secondary pixel electrode, and one discharging capacitor. An electrical amount discharged from the discharging switch located in a central portion of the substrate toward the connected secondary pixel electrodes is less than the electrical amount discharged from the discharging switch located in a border of the substrate toward the connected secondary pixel electrode. In this way, an expected brightness of the liquid crystal panel can be achieved.

### BACKGROUND OF THE INVENTION

1. Field of the Invention

The present disclosure relates to liquid crystal display technology, and more particularly to an array substrate and a liquid crystal display (LCD).

2. Discussion of the Related Art

A LCD usually include an array substrate, a color filter (CF) substrate, and a liquid crystal layer arranged between the array substrate and the CF substrate. The LCD includes a plurality of pixel cells. Each pixel cell includes pixel electrodes, which is made by ITO, arranged on the array substrate, and a common electrode arranged on the CF substrate. The pixel electrodes and the common electrode on the CF substrate form an electrical field so as to control the alignment of the liquid crystal molecules arranged within a liquid crystal layer between the array substrate and the CF substrate.

The array substrate includes scanning lines arranged in a row direction, and data lines arranged in a column direction. The scanning lines intersect with the data lines but the scanning lines and the data lines are electrically isolated from each other. The pixel electrodes and thin film transistors (TFTs) are arranged within a plurality of cell areas defining by the scanning lines and the data lines. Gates of the TFTs electrically connects to the scanning lines. Sources of the TFTs electrically connects to one closest data line. Drains of the TFTs electrically connects to the pixel electrode within the same cell area.

When the data lines obtain data signals from the data driver and the scanning lines obtain scanning signals from the scanning driver, electrical levels of the pixel electrode change. As such, the alignment of the liquid crystal molecules within the liquid crystal layer changes due to the electrical levels applied to the liquid crystal capacitors have changed. In this way, the light transmission rate of the pixels is controlled, and so does the display brightness.

Usually, the pixel electrodes are charged by a reference voltage (Vest Vcom) via TFTs. Though the pixel electrodes are charge by the same reference voltage, but different RC delay exists due to the signal transmission between the Gate line of the TFT and the scanning line. As such, the charging rate of the pixels located in a central portion is smaller than that of the pixels located in a border. The different charging rate may result in that the electrical level of the pixels in the central portion is smaller than that in the border. The alignment of the liquid crystal molecules are different. When the liquid crystal panel displays grayscale images, the brightness of the border is obvious higher than that of the central portion such that the border of the panel seems paler.

### SUMMARY

The object of the invention is to provide an array substrate and a liquid crystal device with an expected brightness.

In one aspect, an array substrate includes: a substrate; a plurality of scanning lines and a plurality of data lines arranged on the substrate; a plurality of pixel electrodes arranged on the substrate, and each pixel electrode a main pixel electrode and a secondary pixel electrode; a plurality of main pixel switches, a plurality of secondary pixel switches, a plurality of discharging switches, and a plurality of discharging capacitors arranged on the substrate; wherein a control end, a first end and a second end of each main pixel switch respectively connects to one scanning line, one data line, and one main pixel electrode, the control end, the first end, and the second end of each secondary pixel switch respectively connects to one scanning line, one data line, and one secondary pixel electrode, the control end, the first end, and the second end of each discharging switch respectively connects to one scanning line, one secondary pixel electrode, and one discharging capacitors; and during a displaying process, an electrical amount discharged from the discharging switch located in a central portion of the substrate toward the connected secondary pixel electrodes is less than the electrical amount discharged from the discharging switch located in a border of the substrate toward the connected secondary pixel electrode.

Wherein a capacitance of the charging capacitors gradually increases from the central portion to the charging capacitors in the border of the substrate.

Wherein a size of the channel of the discharging switch increases from the central portion to discharging switch in the border of the substrate.

In another aspect, a liquid crystal device includes: an array substrate comprising a substrate; a plurality of scanning lines and a plurality of data lines arranged on the substrate; a plurality of pixel electrodes arranged on the substrate, and each pixel electrode a main pixel electrode and a secondary pixel electrode; a plurality of main pixel switches, a plurality of secondary pixel switches, a plurality of discharging switches, and a plurality of discharging capacitors arranged on the substrate; wherein a control end, a first end and a second end of each main pixel switch respectively connects to one scanning line, one data line, and one main pixel electrode, the control end, the first end, and the second end of each secondary pixel switch respectively connects to one scanning line, one data line, and one secondary pixel electrode, and the control end, the first end, and the second end of each discharging switch respectively connects to one scanning line, one secondary pixel electrode, and one discharging capacitors; and during a displaying process, an electrical amount discharged from the discharging switch located in a central portion of the substrate toward the connected secondary pixel electrodes is less than the electrical amount discharged from the discharging switch located in a border of the substrate toward the connected secondary pixel electrode.

Wherein a capacitance of the charging capacitors gradually increases from the central portion to charging capacitors in the border of the substrate.

Wherein a size of the channel of the discharging switch increases from the central portion to the discharging switch in the border of the substrate.

In another aspect, a liquid crystal device includes an array substrate. The array substrate includes: a substrate; a plurality of scanning lines and a plurality of data lines arranged on the substrate, a plurality of pixel electrodes arranged on the substrate, and each pixel electrode a main pixel electrode and a secondary pixel electrode; a plurality of main pixel switches, a plurality of secondary pixel switches, a plurality of discharging switches, and a plurality of discharging capacitors arranged on the substrate; wherein a control end, a first end and a second end of each main pixel switch respectively connects to one scanning line, one data line, and one main pixel electrode, the control end, the first end, and the second end of each secondary pixel switch respectively connects to scanning line, one data line, and one secondary pixel electrode, the control end, the first end, and the second end of each discharging switch respectively connects to one scanning line, one secondary pixel electrode, and one discharging capacitors; and during a displaying process, a total capacitance of at least a portion of the pixel electrodes are different after the discharging switches conduct a discharging process toward the connected second pixel electrodes such that a display brightness corresponding to the array substrate matches an expected distribution.

Wherein an electrical amount discharged from the discharging switches located in the central portion of the substrate to the connected second pixel electrode is less than that discharged amount from the discharging switches located in the border of the substrate to the connected second pixel electrode so as to obtain an uniform display brightness for the array substrate.

Wherein a capacitance of the charging capacitors gradually increases from the central portion to the charging capacitors in the border of the substrate.

Wherein a size of the channel of the discharging switch increases from the central portion to the discharging switch in the border of the substrate.

In view of the above, the discharging switches located in the central portion discharges a smaller electrical amount toward the connected secondary pixel electrodes than the discharging switches located in the border. As such, the issue that a smaller brightness occurs in the central portion of the substrate can be solved as the pixel electrodes located in the central portion has a larger electrical amount. Thus, the brightness of the liquid crystal panel is ensured.

Specifically, the display brightness of the central portion may be increased by gradually increasing the electrical amount of the secondary pixel electrodes located from the central portion to the border of the substrate. Alternatively, the display brightness of the border may be decreased by gradually decreasing the electrical amount of the secondary pixel electrodes located from the central portion to the border of the substrate.

### BRIEF DESCRIPTION OF THE DRAWINGS

FIG. 1 is a schematic view of the array substrate in accordance with one embodiment.

FIG. 2 is a schematic view of the circuit of the array substrate in accordance with one embodiment.

FIG. 3 is a schematic view of the circuit of the array substrate in accordance with another embodiment.

FIG. 4 is a schematic view of the LCD in accordance with one embodiment.

FIG. 5 is a schematic view of the LCD in accordance with another embodiment.

### DETAILED DESCRIPTION OF THE EMBODIMENTS

Embodiments of the invention will now be described more fully hereinafter with reference to the accompanying drawings, in which embodiments of the invention are shown.

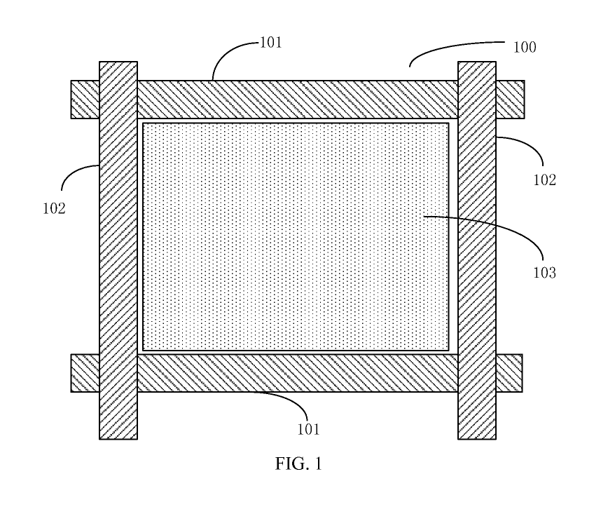

FIG. 1 is a schematic view of the array substrate in accordance with one embodiment.

As shown in FIG. 1, the array substrate includes a substrate 100, a plurality of scanning lines 101 and a plurality of data lines 102. The intersecting scanning lines and the data lines are electrically isolated from each other. The array substrate further includes a plurality of pixel electrodes 103. It is to be noted that only one pixel electrode is shown in FIG. 1.

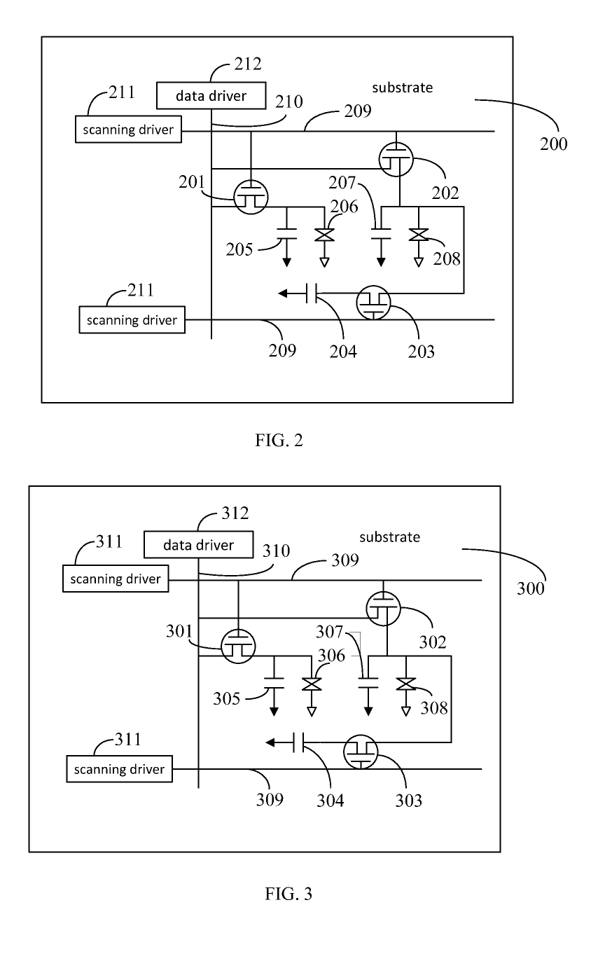

FIG. 2 is a schematic view of the circuit of the array substrate in accordance with one embodiment.

As shown in FIG. 2, the array substrate includes a substrate 200, each of the pixel electrodes on the substrate 200 includes a main pixel electrode 205 and a secondary pixel electrode 207.

The array substrate includes a plurality of main pixel switches 201, a plurality of secondary pixel switches 202, and a plurality of discharging capacitors 204. As shown in FIG. 2, a control end, a first end and a second end of each main pixel switch 201 respectively connects to one scanning line 209, one data line 210, and one main pixel electrode 205. The control end, the first end, and the second end of each secondary pixel switch 202 respectively connects to scanning line 209, one data line 210, and one secondary pixel electrode 207. The control end, the first end, and the second end of each discharging switch 203 respectively connects to one scanning line 209, one secondary pixel electrode 208, and one discharging capacitors 204.

Referring to FIG. 2, the array substrate further includes a scanning driver 211, a data driver 212 connecting with the data line 210. The scanning driver 211 is configured for providing scanning signals for the scanning line 209. The data driver 212 is configured for providing the data signals for the data line 210.

During operations, the scanning driver 211 outputs the scanning signals to the scanning line 209. The main pixel switch 201 connected with the main pixel electrode 205 and the secondary pixel switch 202 connected with the secondary pixel electrode 207 are turn on. The data signals outputted from the data driver 212 are respectively transmitted to the main pixel electrode 205 and the secondary pixel electrode 207 for charging via the data line 210. After the charging process is completed, the main pixel switch 201 and the secondary pixel switch 202 are turn off. At this moment, the scanning driver 211 outputs the scanning signals to a discharging switch 203 to turn it out so as to discharge the secondary pixel electrode 207. In addition, during a displaying process, an electrical amount discharged from the discharging switch 203 located in a central portion of the substrate 200 toward the connected secondary pixel electrodes 207 is less than the electrical amount discharged from the discharging switch 203 located in a border of the substrate 200 toward the connected secondary pixel electrode 207. In the embodiment, the capacity of the discharging capacitors 204 are different in accordance with its location. The discharging capacitors 204 located in the central portion have the smallest capacity, and the discharging capacitors 204 located in the border have the greatest capacity. With such configuration, the electrical amount for the secondary pixel electrodes is also increased gradually from the central portion to the border of the substrate. In this way, the display brightness of the central portion of the liquid crystal panel is also increases. Alternatively, the electrical amount for the secondary pixel electrodes is decreased gradually from the central portion to the border of the substrate to reduce the display brightness of the border of the liquid crystal panel. In this way, the uniformity and the brightness of the liquid crystal panel is enhanced. In other embodiments, a size of the channel of the discharging switch 203 gradually increases from the central portion to discharge switch 203 in the border to ensure that a larger electrical amount is discharged from the secondary pixel electrodes 207 located in the border within the same discharging duration. As such, the voltage of the secondary pixel electrode 207 located in the central portion is higher than that of the secondary pixel electrode 208 located in the border of the substrate 200.

In view of the above, the discharging switches located in the central portion discharges a smaller electrical amount toward the connected secondary pixel electrodes than the discharging switches located in the border. As such, the issue that a smaller brightness occurs in the central portion of the substrate can be solved as the pixel electrodes located in the central portion has a larger electrical amount. Thus, the brightness of the liquid crystal panel is ensured.

Specifically, the display brightness of the central portion may be increased by gradually increasing the electrical amount of the secondary pixel electrodes located from the central portion to the border of the substrate. Alternatively, the display brightness of the border may be decreased by gradually decreasing the electrical amount of the secondary pixel electrodes located from the central portion to the border of the substrate.

FIG. 3 is a schematic view of the circuit of the array substrate in accordance with another embodiment.

The array substrate 300 includes a substrate, a plurality of scanning lines 309 and a plurality of data lines 310. The array substrate further includes a plurality of pixel electrodes arranged on the array substrate 300. Each of the pixel electrode includes a first pixel electrode 305 and a second pixel electrode 307.

A plurality of first pixel transistors 301, a plurality of second pixel electrodes 302, a plurality of discharging switches 303, and a plurality of discharging capacitors 304 arranged on the substrate.

The control end, the first end and the second end of each first pixel transistors 301 respectively connects to one scanning line 309, one data line 310, and one first pixel electrode 306. The control end, the first end, and the second end of each second pixel electrodes 302 respectively connect to one scanning line 306, one data line 310, and one secondary pixel electrode 308. The control end, the first end, and the second end of each discharging switch respectively connects to one scanning line 309, one secondary pixel electrode 308, and one discharging capacitors 304.

In the embodiment, the array substrate further includes the scanning driver 311 connected with the scanning line 309, and the data driver 312 connected with the data line 310. The scanning driver 311 is configured for providing the scanning signals for the scanning line 309, and the data driver 312 is configured for providing the data signals for the data lines.

During operations, the scanning driver 311 outputs the scanning signals to the scanning line 309. The secondary pixel switches 302 connected with the first pixel transistors 301 and the secondary pixel electrode 308 are turn on. The data signals outputted from the data driver 312 respectively charges the first pixel electrode 305 and the second pixel electrode 307 via the data line 310. After the charging process is completed, the first pixel transistors 301 and the second pixel electrodes 302 are turn off. At this moment, the scanning driver 311 outputs the scanning signals to the discharging switches 303 so as to turn it on and to discharge the secondary pixel electrode 308.

Each discharging switches 303 on the array substrate conducts the discharging process on the connected second pixel electrodes 307. The total capacitance of the at least first pixel electrode and the second pixel electrode are different such that the display brightness corresponding to the array substrate matches an expected distribution.

In one embodiment, the electrical amount discharged from the discharging switches 303 located in the central portion of the substrate 300 to the connected second pixel electrode 307 is less than that discharged amount from the discharging switches 303 located in the border of the substrate 300 to the connected second pixel electrode 307 so as to obtain a uniform display brightness for the array substrate.

In order to achieve the above purpose, the capacitance of the discharging capacitors 304 is configured to be gradually increased from the central portion to the border of the substrate 300. In this way, the electrical amount discharged from the discharging switches 303 located in the central portion of the substrate 300 to the connected second pixel electrode 307 is less than that discharged amount from the discharging switches 303 located in the border of the substrate 300 to the connected second pixel electrode 307.

Alternatively, the discharging capability of the discharging switches 303, such as the size of the channel, may be increased gradually central portion to the border of the substrate. As such, a smaller electrical amount is discharged from the discharging switches 303 located in the central portion to the connected second pixel electrode 307 than that discharged from the discharging switches 303 located in the border of the substrate 300 within the same discharging duration. Also, the voltage of the secondary pixel electrode 308 located in the central portion is a little bit higher than that located in the border.

It is to be noted that the total electrical amount of the first pixel electrode 305 and the second pixel electrode 307 are different. In other embodiments, the electrical amount of the pixels arranged in the border of the substrate may be increased by, but not limited to, increasing the electrical amount of the pixels of the second pixel electrodes. The uniform brightness of the liquid crystal panel may be enhanced by changing the electrical amount of the pixels of the second pixel electrodes.

In view of the above, the discharging switches located in the central portion discharges a smaller electrical amount toward the connected secondary pixel electrodes than the discharging switches located in the border. As such, the issue that a smaller brightness occurs in the central portion of the substrate can be solved as the pixel electrodes located in the central portion has a larger electrical amount. Thus, the brightness of the liquid crystal panel is ensured.

Specifically, the display brightness of the central portion may be increased by gradually increasing the electrical amount of the secondary pixel electrodes located from the central portion to the border of the substrate. Alternatively, the display brightness of the border may be decreased by gradually decreasing the electrical amount of the secondary pixel electrodes located from the central portion to the border of the substrate.

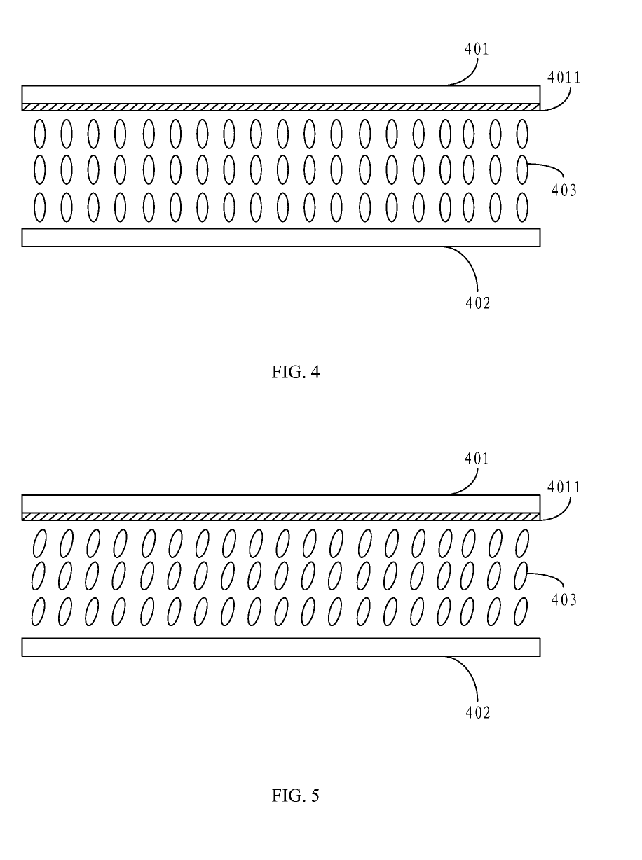

FIG. 4 is a schematic view of the LCD in accordance with one embodiment. In this embodiment, the LCD includes an array substrate 401 recited in the above embodiment, i.e., the array substrate as shown in FIG. 2. Corresponding to FIG. 2, the pixel electrode 4011 is arranged on the array substrate. The array substrate further includes a CF substrate 402 being arranged opposite to the array substrate 401, and liquid crystal molecules 403.

Referring to FIGS. 2 and 4, during operations, the scanning driver 211 outputs the scanning signals to the scanning line 209. Each main pixel switch 201 and secondary pixel switch 202 are turned on, and all of the discharging switches 203 are turned off. The data signals outputted from the data driver 212 respectively charges the main pixel electrode 205 and the secondary pixel electrode 207 via the data line 210. After the charging process is complete, each main pixel switch 201 and secondary pixel switch 202 are turned off. The scanning driver 211 outputs the scanning signals to turn on the discharging switch 203. The discharging switch 203 discharges the connected secondary pixel electrodes 207. The electrical amount discharged from the discharging switch 203 located in the central portion to the connected secondary pixel electrode 207 is less than that discharged from the discharging switch 203 located in the border to the connected secondary pixel electrode 207.

The pixel electrode 4011 on the array substrate 401 and a common electrode (not shown) on the CF substrate 402 form an electrical field therebetween. Due to the above discharging process toward the secondary pixel electrode 207, the electrical amount stored on each of the pixel electrodes on the substrate 200 corresponds to its location. Thus, the alignment of the liquid crystal molecules 403 between the array substrate 401 and the CF substrate 402 are the same due to the electrical field. As shown in FIG. 5, such alignment results in an uniform brightness of the liquid crystal panel.

In view of the above, the discharging switches located in the central portion discharges a smaller electrical amount toward the connected secondary pixel electrodes than the discharging switches located in the border. As such, the issue that a smaller brightness occurs in the central portion of the substrate can be solved as the pixel electrodes located in the central portion has a larger electrical amount. Thus, the brightness of the liquid crystal panel is ensured.

Specifically, the display brightness of the central portion may be increased by gradually increasing the electrical amount of the secondary pixel electrodes located from the central portion to the border of the substrate. Alternatively, the display brightness of the border may be decreased by gradually decreasing the electrical amount of the secondary pixel electrodes located from the central portion to the border of the substrate.

In another embodiment, the LCD includes the array substrate as shown in FIG. 3. After performing the discharging process conducted by each discharging switches to the connected second pixel electrodes on the array substrate, the total capacitance of the at least first pixel electrode and the second pixel electrode are different. As such, the display brightness corresponding to the array substrate matches an expected distribution.

In view of the above, the discharging switches located in the central portion discharges a smaller electrical amount toward the connected secondary pixel electrodes than the discharging switches located in the border. As such, the issue that a smaller brightness occurs in the central portion of the substrate can be solved as the pixel electrodes located in the central portion has a larger electrical amount. Thus, the brightness of the liquid crystal panel is ensured.

Specifically, the display brightness of the central portion may be increased by gradually increasing the electrical amount of the secondary pixel electrodes located from the central portion to the border of the substrate. Alternatively, the display brightness of the border may be decreased by gradually decreasing the electrical amount of the secondary pixel electrodes located from the central portion to the border of the substrate.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An array substrate, comprising:
a substrate;
a plurality of scanning lines and a plurality of data lines arranged on the substrate;
a plurality of pixel electrodes arranged on the substrate, and each pixel electrode a main pixel electrode and a secondary pixel electrode;
a plurality of main pixel switches, a plurality of secondary pixel switches, a plurality of discharging switches, and a plurality of discharging capacitors arranged on the substrate;
wherein a control end, a first end and a second end of each main pixel switch respectively connects to one scanning line, one data line, and one main pixel electrode, the control end, the first end, and the second end of each secondary pixel switch respectively connects to one scanning line, one data line, and one secondary pixel electrode, the control end, the first end, and the second end of each discharging switch respectively connects to one scanning line, one secondary pixel electrode, and one discharging capacitors; and
during a displaying process, an electrical amount discharged from the discharging switch located in a central portion of the substrate toward the connected secondary pixel electrodes is less than the electrical amount discharged from the discharging switch located in a border of the substrate toward the connected secondary pixel electrode.

2. The array substrate of claim 1, wherein a capacitance of the charging capacitors gradually increases from the central portion to the charging capacitors in the border of the substrate.

3. The array substrate of claim 2, wherein a size of the channel of the discharging switch increases from the central portion to discharging switch in the border of the substrate.

4. A liquid crystal device, comprising:
an array substrate comprising a substrate;
a plurality of scanning lines and a plurality of data lines arranged on the substrate;
a plurality of pixel electrodes arranged on the substrate, and each pixel electrode a main pixel electrode and a secondary pixel electrode;
a plurality of main pixel switches, a plurality of secondary pixel switches, a plurality of discharging switches, and a plurality of discharging capacitors arranged on the substrate;
wherein a control end, a first end and a second end of each main pixel switch respectively connects to one scanning line, one data line, and one main pixel electrode, the control end, the first end, and the second end of each secondary pixel switch respectively connects to one scanning line, one data line, and one secondary pixel electrode, and the control end, the first end, and the second end of each discharging switch respectively connects to one scanning line, one secondary pixel electrode, and one discharging capacitors; and
during a displaying process, an electrical amount discharged from the discharging switch located in a central portion of the substrate toward the connected secondary pixel electrodes is less than the electrical amount discharged from the discharging switch located in a border of the substrate toward the connected secondary pixel electrode.

5. The liquid crystal device of claim 4, wherein a capacitance of the charging capacitors gradually increases from the central portion to charging capacitors in the border of the substrate.

6. The liquid crystal device of claim 4, wherein a size of the channel of the discharging switch increases from the central portion to the discharging switch in the border of the substrate.

7. A liquid crystal device, comprising:
an array substrate comprises:
a substrate;
a plurality of scanning lines and a plurality of data lines arranged on the substrate, a plurality of pixel electrodes arranged on the substrate, and each pixel electrode a main pixel electrode and a secondary pixel electrode;
a plurality of main pixel switches, a plurality of secondary pixel switches, a plurality of discharging switches, and a plurality of discharging capacitors arranged on the substrate;
wherein a control end, a first end and a second end of each main pixel switch respectively connects to one scanning line, one data line, and one main pixel electrode, the control end, the first end, and the second end of each secondary pixel switch respectively connects to scanning line, one data line, and one secondary pixel electrode, the control end, the first end, and the second end of each discharging switch respectively connects to one scanning line, one secondary pixel electrode, and one discharging capacitors; and
during a displaying process, a total capacitance of at least a portion of the pixel electrodes are different after the discharging switches conduct a discharging process toward the connected second pixel electrodes such that a display brightness corresponding to the array substrate matches an expected distribution.

8. The liquid crystal device of claim 7, wherein an electrical amount discharged from the discharging switches located in the central portion of the substrate to the connected second pixel electrode is less than that discharged amount from the discharging switches located in the border of the substrate to the connected second pixel electrode so as to obtain an uniform display brightness for the array substrate.

9. The liquid crystal device of claim 7, wherein a capacitance of the charging capacitors gradually increases from the central portion to the charging capacitors in the border of the substrate.

10. The liquid crystal device of claim 7, wherein a size of the channel of the discharging switch increases from the central portion to the discharging switch in the border of the substrate.
